(19) United States
(12) Patent Application Publication
(10) Pub. No.: US 2009/0172353 A1
(43) Pub. Date: Jul. 2, 2009

(54) SYSTEM AND METHOD FOR ARCHITECTURE-ADAPTABLE AUTOMATIC PARALLELIZATION OF COMPUTING CODE

(75) Inventors: Jimmy Zhigang Su, Milpitas, CA (US); Archana Ganapathi, Palo Alto, CA (US); Mark Roblat, Berkeley, CA (US)

Correspondence Address: PERKINS COIE LLP, P.O. BOX 1208, SEATTLE, WA, 98111-1208, US

(73) Assignee: Optillel Solutions, Milpitas, CA (US)

(21) Appl. No.: 12/331,902

(22) Filed: Dec. 10, 2008

Related U.S. Application Data
(60) Provisional application No. 61/017,479, filed on Dec. 28, 2007.

(51) Int. Cl. G06F 15/76; G06F 9/06

(52) U.S. Cl. 712/30; 712/E09.003

(57) ABSTRACT

Systems and methods for architecture-adaptable automatic parallelization of computing code are described herein. In one aspect, embodiments of the present disclosure include a method of generating a plurality of instruction sets from a sequential program for parallel execution in a multi-processor environment, which may be implemented on a system, of, identifying an architecture of the multi-processor environment in which the plurality of instruction sets are to be executed, determining running time of each of a set of functional blocks of the sequential program based on the identified architecture, determining communication delay between a first computing unit and a second computing unit in the multi-processor environment, and/or assigning each of the set of functional blocks to the first computing unit or the second computing unit based on the running times and the communication time.

### CLAIM OF PRIORITY

This application claims priority to U.S. Provisional Patent Application No. 60/017,479 entitled “SYSTEM AND METHOD FOR ARCHITECTURE-SPECIFIC AUTOMATIC PARALLELIZATION OF COMPUTING CODE”, which was filed on Dec. 28, 2007, the contents of which are expressly incorporated by reference herein.

### TECHNICAL FIELD

The present disclosure relates generally to parallel computing and is in particular related to automated generation of parallel computing code.

### BACKGROUND

Traditionally, computing code is written for sequential execution on a computing system with a single core processor. Serial computing code typically includes instructions that are executed sequentially, one after another. With single core processor execution of serial code, usually, one instruction may execute at one time. Therefore, a latter instruction usually cannot be processed until a previous instruction has been executed.

Execution of serial computing code can be expedited by increased processors clock rate. The increase of clock rate decreases the amount of time needed to execute an instruction and therefore enhances computing performance. Frequency scaling of processor clocks has thus been the predominant method of improving computing power and extending Moore's Law.

In contrast to serial computing code, parallel computing code can be executed simultaneously. Parallel code execution operates principally based on the concept that algorithms can typically be broken down into instructions that can be executed concurrently. Parallel computing is becoming a paradigm through which computing performance is enhanced, for example, through parallel computing with various classes of parallel computers.

One class of parallel computers utilizes a multicore processor with multiple independent execution units (e.g., cores). For example, a dual-core processor includes two cores and a quad-core process includes four cores. Multicore processors are able to issue multiple instructions per cycle from multiple instruction streams. Another class of parallel computers utilizes symmetric multiprocessors (SMP) with multiple identical processors that share memory storage and can be connected via a bus.

Parallel computers can also be implemented with distributed computing systems (or, distributed memory multiprocessor) where processing elements are connected via a network. For example, a computer cluster is a group of coupled computers. The cluster components are commonly coupled to one another through a network (e.g., LAN). A massively parallel processor (MPP) is a single computer with multiple independent processors and/or arithmetic units. Each processor in a massively parallel processor computing system can have its own memory, a copy of the operating system, and/or applications.

In addition, in grid computing, multiple independent computing systems connected by a network (e.g., Internet) are utilized. Further, parallel computing can utilize specialized parallel computers. Specialized parallel computers include, but are not limited to, reconfigurable computing with field-programmable gate arrays, general-purpose computing on graphics processing units (GPGPU), application-specific integrated circuits (ASICS), and/or vector processors.

### SUMMARY OF THE DESCRIPTION

System and method for architecture-adaptable automatic parallelization of computing code are described here. Some embodiments of the present disclosure are summarized in this section.

In one aspect, embodiments of the present disclosure include a method, which may be implemented on a system, of generating a plurality of instruction sets from a sequential program for parallel execution in a multi-processor environment, identifying an architecture of the multi-processor environment in which the plurality of instruction sets are to be executed, determining running time of each of a set of functional blocks of the sequential program based on the identified architecture, determining communication delay between a first computing unit and a second computing unit in the multi-processor environment, and/or assigning each of the set of functional blocks to the first computing unit or the second computing unit based on the running times and the communication time.

One embodiment further includes determining communication delay for transmitting between the first computing unit and a third computing unit and generating the plurality of instruction sets to be executed in the multi-processor environment to perform a set of functions represented by the sequential program. The parallel code comprises instructions typically dictates the communication and synchronization among the set of processing units to perform the set of functions.

One embodiment further includes, monitoring activities of the first and second computing units in the multi-processor environment when executing the plurality of instruction sets to detect load imbalance among the first and second computing units. In one embodiment, in response to detecting load imbalance among the first and second computing units, assignment of the set of functional blocks to the first and second computing units is dynamically adjusted.

In one aspect, embodiments of the present disclosure includes a system of a synthesizer module including a resource computing module to determine resource intensity of each of a set of functional blocks of a sequential program based on a particular architecture of the multi-processor environment, a resource database to store data comprising the resource intensity of each of the set of functional blocks and communication times among computing units in the multi-processor environment; a scheduling module to assign the set of functional blocks to the computing units for execution; when, in operation, establishes a communication with the resource database to retrieve one or more of the resource intensity and the communication times, and/or a parallel code generator module to generate parallel code to be executed by the computing units to perform a set of functions represented by the sequential program.

The system may further include a hardware architecture specifier module coupled to the resource computing module and/or a parser data retriever module, coupled to the scheduling module to provide parser data of each of the set of functional blocks to the scheduling module, and/or a sequential code processing unit coupled to the parallel code generator module.

In one aspect, embodiments of the present disclosure include an optimization system including a converter module for determining parser data of a set of functional blocks of a sequential program, a synthesis module for generating a plurality of instruction sets from the sequential program for parallel execution in a multi-processor environment, a dynamic monitor module to monitor activities of the computing units in the multi-processor environment to detect load imbalance, and/or a load adjustment module communicatively coupled to the dynamic monitor module, when, in operation, dynamically adjusts the assignment of the set of functional blocks to the computing units in response to the dynamic monitor module detecting load imbalance among the computing units.

The present disclosure includes methods and systems which perform these methods, including processing systems which perform these methods, and computer readable media which when executed on processing systems cause the systems to perform these methods. Other features of the present disclosure will be apparent from the accompanying drawings and from the detailed description which follows.

### BRIEF DESCRIPTION OF THE DRAWINGS

FIG. 1 illustrates a diagrammatic representation of a computing code with multiple parallel processes comprising functional blocks, according to one embodiment.

FIG. 2 illustrates an example block diagram of an optimization system to automate parallelization of computing code, according to one embodiment.

FIG. 3A illustrates an example block diagram of processes performed by an optimization system during compile time and run time, according to one embodiment.

FIG. 3B illustrates an example block diagram of the synthesis module, according to one embodiment.

FIG. 4 depicts a flow chart illustrating an example process for generating a plurality of instruction sets from a sequential program for parallel execution in a multi-processor environment, according to one embodiment.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the invention. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include systems and methods for architecture-specific automatic parallelization of computing code.

In one aspect, the present disclosure relates to determining run-time and/or compile-time attributes of functional blocks of a sequential code of a particular programming language. The attributes of a functional block can, in most instances be obtained from the parser data for a particular code sequence represented by a block diagram. The attributes are typically language dependent (e.g., LabView, Simulink, etc.) and can include, but way of example, but not limitation, resource requirements, estimated running time (e.g., worst case running time), the relationship between a block with other blocks, how the block is called, re-entrancy (e.g., whether a block can be called by multiple threads), and/or ability to access (e.g., read/write) to global variables, etc.

In one aspect, the present disclosure relates to automatically determining estimated running time for the functional blocks and/or communication costs based on the user specified architecture (e.g., multi-processor, cluster, multi-core, etc.). Communication costs including by way of example but not limitation, network communication time (e.g., latency and/or bandwidth), processor communication time, memory and processor communication time, etc. In some instances, network communication time can be determined by performing benchmark tests on the specific architecture/hardware configuration. Similarly, memory and processor communication costs can be determined via datasheets and/or other specifications.

In one aspect, the present disclosure relates to run-time optimization of computing code parallelization. In some instances, data dependent functional blocks may cause load imbalance in processors due to lack of availability of data until run time. Therefore, the processors can be dynamically monitored to detect processor load imbalance by, for example, collecting timing information of the functional blocks during program execution. For example, a processor detected with higher idle times can be assigned another block for execution from a processor that is substantially busier. Block assignment can be re-adjusted to facilitate load balancing.

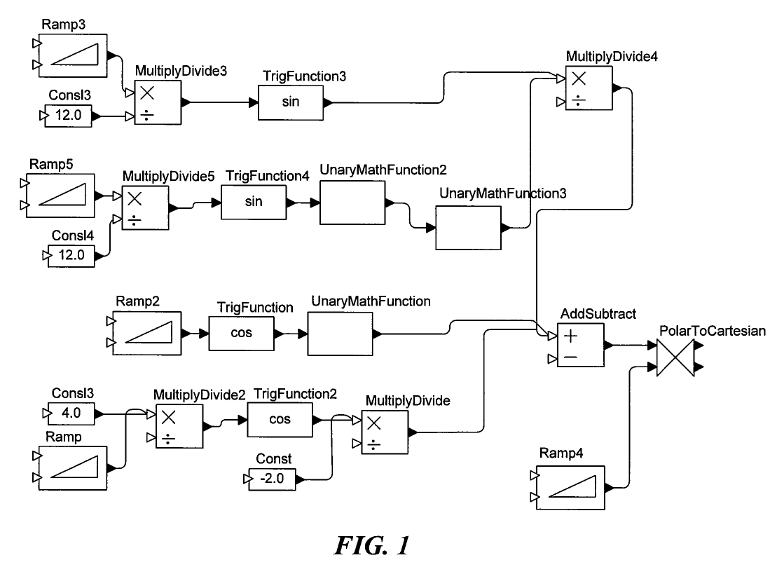

FIG. 1 illustrates a diagrammatic representation of a computing code with multiple parallel processes comprising functional blocks, according to one embodiment.

The example computing code illustrated includes four parallel processes. Each process includes multiple functional blocks. In general, each of these four processes can be assigned to a different computing unit (e.g., processor, core, and/or computer) in a multi-processor environment with the goal of minimizing the makespan (e.g., elapsed time) of program execution. A multi-processor environment can be, one or more of, or a combination of, a multi-processor environment, a multi-core environment, a multi-thread environment, multi-computer environment, a cell, an FPGA, a GPU, and/or a computer cluster, etc.

In some instances, the functional blocks of a particular parallel process can be executed by different computing units to optimize the makespan. For example, in the event that the multiplication/division functional block is more time intensive than the trigonometric function block, one processor may execute two trigonometric function blocks from different parallel processes while another process executes a multiplication/division block for load balancing (e.g., balancing load among the available processors).

Note that inter-processor communication contributes to execution time overhead and is typically also factored into the assignment process of functional blocks to computing units. Inter-processor communication delay can include, by way of example, but not limitation, communication delay for transferring data between source and destination computing units and/or arbitration delay for acquiring access privileges to interconnection networks. Arbitration delays typically depend on network congestion and/or arbitration strategy of the particular network.

Communication delays usually can depend on the amount of data transmitted and/or the distance of the transmission path and can be determined based on the specific architecture of the multi-processor environment. For example, architectural models for multi-processor environments can be tightly coupled or loosely coupled. Tightly coupled multiprocessors typically communicate via a shared memory hence the rate at which data can be transmitted/received between processors is related to memory latency (e.g., memory access time, or, the time which elapses between making a request and receiving a response) and/or memory bandwidth (e.g., rate at which data can be read from or written to memory by a processor or computing unit). The processors or processing units in a tightly coupled multi-processor environment typically include memory cache (e.g., memory buffer).

Loosely coupled processors (e.g., multi-computers) communicate via passing messages and/or data via an interconnection network whose performance is usually a function of network topology (e.g., static or dynamic). For example, static network topologies include, but are not limited to, a share-bus configuration, a star configuration, a tree configuration, a mesh configuration, a binary hypercube configuration, a completely connected configuration, etc. The performance/cost metrics of a static network can affect assignment of functional blocks to computing units in a multi-processor environment. The performance metrics can include by way of example but not limitation, average message traffic delay (mean internode distance), average message traffic density per link, number of communication ports per node (degree of a node), number of redundant paths (fault tolerance), ease of routing (ease of distinct representation of each node), etc.

Further, processor load balancing (e.g., to distribute computation load evenly among the computing units in the multi-processing environment) is, in one embodiment, considered in conjunction with estimated scheduling overhead and/or communication overhead (e.g., latency and/or synchronization) that is, in most instances, architecture/network specific for assigning functional blocks to processors for auto-parallelization. Furthermore, load balance may oftentimes depend on the dynamic behavior of the program in execution since some programs have data-dependent behaviors and performances. Synchronization is involved with the time-coordination of computational activities associated with executing functional blocks in a multi-processor environment.

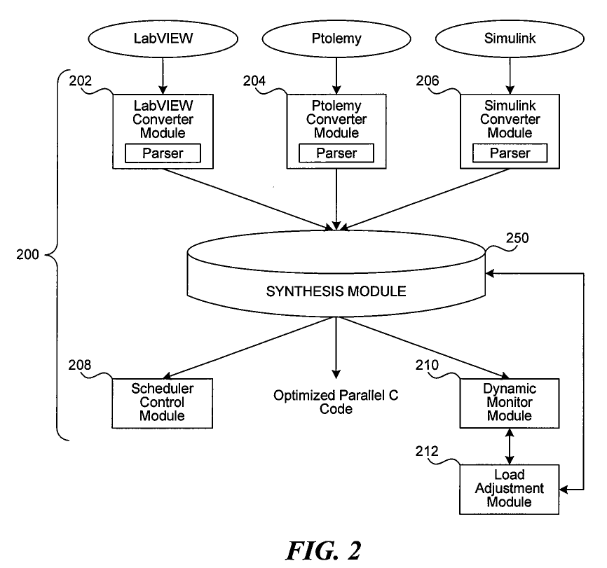

FIG. 2 illustrates an example block diagram of an optimization system 200 to automate parallelization of computing code, according to one embodiment.

The example block diagram illustrates a number of example programming languages (e.g., LabVIEW, Ptolemy, and/or Simulink, etc.) whose sequential code can be automatically parallelized by the optimization system 200. The programming languages whose sequential codes can be automatically parallelized are not limited to those shown in the FIG. 2.

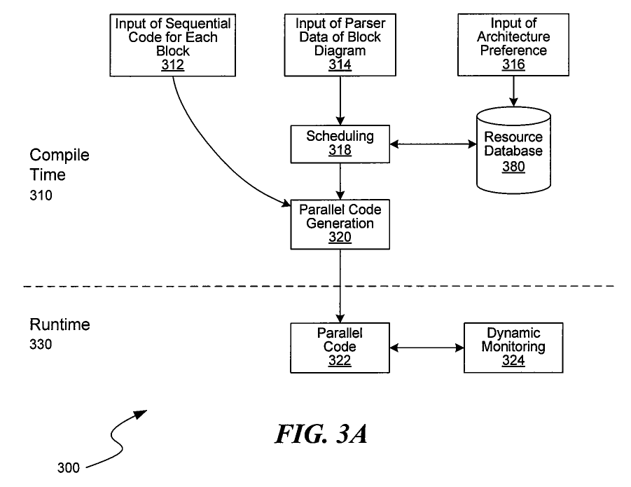

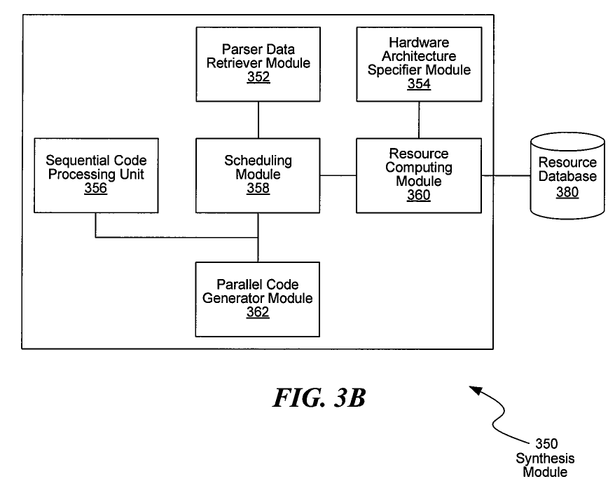

The optimization system 200 can include converter modules 202, 204, and/or 206, a synthesis module 250, a scheduler control module 208, a dynamic monitor module 210, and/or a load adjustment module 212. Additional or fewer modules can be included without deviating from the novel art of this disclosure. In addition, each module in the example of FIG. 2 can include any number and combination of sub-modules, and systems, implemented with any combination of hardware and/or software modules. The optimization system 200 may be communicatively coupled to a resource database as illustrated in FIGS. 3A-B. In some embodiments, the resource database is partially or wholly internal to the synthesis module 250.

The optimization system 200, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software.

In one embodiment, the sequential code provided by a particular programming language is analyzed by one or more converter modules 202, 204, and 206. The converter modules 202, 204, or 206 can identify the parser data of a functional block of a sequential program. The parser data of each block typically provides information regarding one or more attributes related to a functional block. For example, the input and output of a functional block, the requirements of the inputs/outputs of the block, resource intensiveness, re-entrancy, etc. can be identified from parser outputs. In one embodiment, the parser data is identified and retrieved by the parser module in the converters 202, 204, and 206. Other methods of obtaining functional block level attributes are contemplated and are considered to be within the novel art of the disclosure.

One embodiment of the optimization system 200 further includes a scheduler control module 208. The scheduler control module 208 can be any combination of software agents and/or hardware modules able to assign functional blocks to the computing units in the multi-processor environment. The scheduler control module 208 can use the parser data of each functional block to obtain the estimated running time for functional block to assign the functional blocks to the computing units. Furthermore, the communication cost/delay between the computing units can be determined by the scheduler control module 208 in assigning the blocks to the computing units in the multi-processor environment.

One embodiment of the optimization system 200 further includes the synthesis module 250. The synthesis module 250 can be any combination of software agents and/or hardware modules able to generate a set of instructions from a sequential program for parallel execution in a multi-processor environment. The instruction sets can be executed in the multi-processor environment to perform a set of functions represented by the corresponding sequential program.

The parser data of the functional blocks of sequential code is, in some embodiments, synthesized by the synthesis module 250 using the code from the sequential program to facilitate generation of the set of instructions suitable for parallel execution. In most instances, the architecture of the multi-processor environment is factored into the synthesis process for generation of the set of instructions. The architecture (e.g., type of multi-processor environment and the number of processors/cores) the multi-processor environment is user-specified or automatically detected by the optimization system 200. The architecture can affect the estimated running time for the functional blocks and the communication delay between processors among a network and/or between processors and the memory bus in the multi-processor environment.

The synthesis module 250 can generate instructions for parallel execution that is optimized for the particular architecture of the multi-processor environment and based on the assignment of the functional blocks to the computing units as determined by the scheduler control module 208. Furthermore, the synthesis module 250 allows the instructions to be generated in a fashion that is transparent to the programming language (e.g., independent of the programming language used for the sequential code) of the sequential program since the synthesis process converts sequential code of a particular programming language into sets of instructions that are not language specific (e.g., optimized parallel code in C).

One embodiment of the optimization system 200 further includes the dynamic monitor module 210. The dynamic monitor module 210 can be any combination of software agents and/or hardware modules able to detect load imbalance among the computing units in the multi-processor environment when executing the instructions in parallel.

In some embodiments, during run-time, the computing units in the multi-processor environment are dynamically monitored by the dynamic monitor module 210 to determine the time elapsed for executing a functional block for identifying situations where the load on the available processors is potentially unbalanced. In such a situation, assignment of functional blocks to computing units may be readjusted, for example, by the load adjustment module 212.

FIG. 3A illustrates an example block diagram 300 of processes performed by an optimization system during compile time and run time, according to one embodiment.

During compile time 310, the scheduling process 318 is performed with inputs of parser data of the block diagram 314 of the sequential program and the architecture preference 316 of the multi-processor environment. In addition, data from the resource database 380 can be utilized during scheduling 318 for determining assignment of functional blocks to computing units. The resource database 308 can store data related to running time of the functional blocks and the communication delay and/or costs among processors or memory in the multi-processor environment.

After the scheduling process 318 has assigned the functional blocks to the computing units, the result of the assignment can be used for parallel code generation 320. The input sequential code for the functional blocks 312 are also used in the parallel code generation process 320 in compile time 310. During runtime 330, the parallel code can be executed by the computing units in the multi-processor environment while concurrently being monitored 324 to detect any load imbalance among the computing units.

FIG. 3B illustrates an example block diagram of the synthesis module 350, according to one embodiment.

One embodiment of the synthesis module 350 includes a parser data retriever module 352, a hardware architecture specifier module 354, a sequential code processing unit 356, a scheduling module 358, a resource computing module 360, and/or a parallel code generator module 362. The resource computing module 360 can be coupled to a resource database 380 that is internal or external to the synthesis module 350.

Additional or fewer modules can be included without deviating from the novel art of this disclosure. In addition, each module in the example of FIG. 3B can include any number and combination of sub-modules, and systems, implemented with any combination of hardware and/or software modules. The synthesis module 350 may be communicatively coupled to a resource database 380 as illustrated in FIGS. 3A-B. In some embodiments, the resource database 380 is partially or wholly internal to the synthesis module 350.

The synthesis module 350, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software.

One embodiment of the synthesis module 350 includes the parser data retriever module 352. The parser data retriever module 352 can be any combination of software agents and/or hardware modules able to obtain parser data of the functional blocks from the source code of a sequential program.

The parser data is typically language dependent (e.g., LabVIEW, Simulink, Ptolemy, CAL (Xilinx), SPW (Cadence), Proto Financial (Proto), BioEra, etc.) and can include, but way of example, but not limitation, resource requirements, estimated running time (e.g., worst case running time), the relationship between a block with other blocks, how the block is called, re-entrancy (e.g., whether a block can be called by multiple threads), data dependency of the block, and/or ability to access (e.g., read/write) to global variables, whether a block needs to maintain the state between multiple invocations, etc.

The parser data can be retrieved by analyzing the parser output generated by a compiler or other parser generators for each functional block in the source code, for example, for the functional blocks in a graphical programming language. In one embodiment, the parser data can be retrieved by a parser that analyzes the code or associated files (e.g., the mdl file for Simulink). For a non-graphical sequential code, the user annotations can be used to group sections of codes into blocks. The parser data of the functional blocks can be used by the scheduling module 358 in assigning the functional blocks to computing units in a multi-processor environment. In one embodiment, the parser data retriever module 352 identifies data dependent blocks from the set of functional blocks in the source code for the sequential program.

One embodiment of the synthesis module 350 includes the hardware architecture specifier module 354. The hardware architecture specifier module 354 can be any combination of software agents and/or hardware modules able to determine the architecture (e.g., user specified and/or automatically determined to be, multi-core, multi-processor, computer cluster, cell, FPGA, and/or GPU) of the multi-processor environment in which the instruction sets are to be executed.

The instructions sets are generated from the source code of a sequential program for parallel execution in the multi-processor environment. The architecture the multi-processor environment can be user-specified or automatically detected. The multi-processor environment may include any number of computing units on the same processor, sharing the same memory bus, or connected via a network.

In one embodiment, the architecture of the multi-processor environment is a multi-core processor and the first computing unit is a first core and the second computing unit is a second core. In addition, the architecture of the multi-processor environment can be a networked cluster and the first computing unit is a first computer and the second computing unit is a second computer. In some embodiments, a particular architecture includes a combination of multi-core processors and computers connected over a network. Alternate and additional combinations are contemplated and are also considered to be within the scope of the novel art described herein.

One embodiment of the synthesis module 350 includes the resource computing module 360. The resource computing module 360 can be any combination of software agents and/or hardware modules able to compute or otherwise determine the resources available for processing and storage in the multi-processor environment of any architecture or combination of architectures.

In one embodiment, the resource computing module 360 determines resource intensity of each functional block of a sequential program based on a particular architecture of the multi-processor environment through, for example, determining the running time of each individual functional blocks in a sequential program. The running time is typically determined based on the specific architecture of the multi-processor environment. The resource computing module 360 can be coupled to the hardware architecture specifier module 354 to obtain information related to the architecture of the multi-processor environment for which instruction sets for parallel execution are to be generated.

In addition, the resource computing module 360 can determine the communication delay among computing units in the multi-processor environment. For example, the resource computing module 360 can determine communication delay between a first computing unit and a second computing unit and further between the first computing unit and a third computing unit. The identified architecture is typically used to determine the communication costs between the computing units and any associated memory units in the multi-processor environment. In addition, the identified architecture can be determined via communications with the hardware architecture specifier module 354.

Typically, the communication delay/cost is determined during installation when benchmark tests may be performed, for example, by the resource computing module 360. For example, the latency and/or bandwidth of a network connecting the computing units in the multi-processor environment can be determined via benchmarking. For example, the running time of a functional block can be determined by performing benchmarking tests using varying size inputs to the functional block.

The results of the benchmark tests can be stored in the resource database 3 80 coupled to the resource computing module 358. For example, the resource database 380 can store data comprising the resource intensity the functional blocks and communication delays/times among computing units and memory units in the multi-processor environment.

The communication delay can include the inter-processor communication time and memory communication time. For example, the inter-processor communication time can include the time for data transmission between processors and the memory communication time can include time for data transmission between a processor and a memory unit in the multi-processor environment. In one embodiment, the communication delay, further comprises, arbitration delay for acquiring access to an interconnection network connecting the computing units in the multi-processor environment.

One embodiment of the synthesis module 350 includes the scheduling module 358. The scheduling module 358 is any combination of software agents and/or hardware modules that assigns functional blocks to computing units in a multi-processor environment.

The computing units execute the assigned functional blocks simultaneously to achieve parallelism. The scheduler module 358 can utilize various inputs to determine functional block assignment to processors. For example, the scheduler module 358 communicates with the resource database 380 to obtain estimate running time of the functional blocks and the communication costs for communicating between processors (e.g., via a network, shared-bus, shared memory, etc.). In one embodiment, the scheduler module 358 also receives the parser output of the functional blocks from the parser data retriever module 352 which describes, for example, connections among blocks, reentrancy of the blocks, and/or ability to read/write to global variables.

One embodiment of the synthesis module 350 includes the parallel code generator module 362. The parallel code generator module 362 is any combination of software agents and/or hardware modules that assigns functional blocks to computing units in a multi-processor environment.

The parallel code generator module 362 can, in most instances, receive instructions related to assignment of blocks to computing units, for example, from the scheduling module 358. In addition, the parallel code generator module 362 is further coupled to the sequential code processing unit 356 to receive the sequential code for the functional blocks. The sequential code of each block can be used to generate the parallel code without modification. The parallel code generator module 362 can thus generate instruction sets representing the original source code for parallel execution to perform functions represented by the sequential program. In one embodiment, the instruction sets further include instructions that communication and synchronization among the computing units in the multi-processor environment. Communication between various processing elements is required when the source and destination blocks are assigned to different processing elements. In this case, data is communicated from the source processing element to the destination processing element. Synchronization moderates the communication between the source and destination processing elements and in this situation will not start the execution of the block until the data is received from the source processing element.

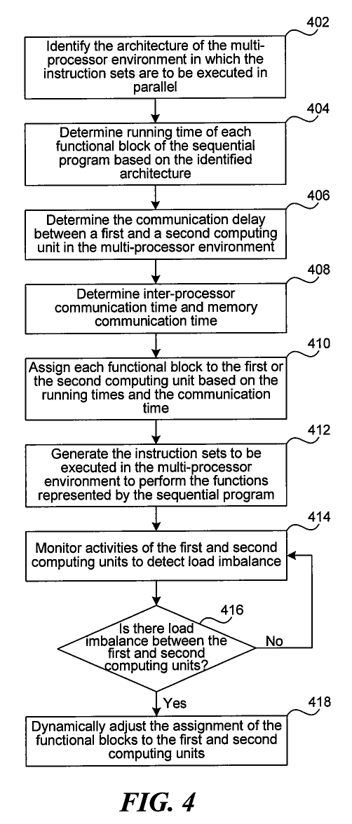

FIG. 4 depicts a flow chart illustrating an example process for generating a plurality of instruction sets from a sequential program for parallel execution in a multi-processor environment, according to one embodiment.

In process 402, the architecture of the multi-processor environment in which the instruction sets are to be executed in parallel is identified. In some embodiments, the architecture is automatically determined without user-specification. Similarly architecture determination can be both user-specified in conjunction with system detection. In process 404, running time of each functional block of the sequential program is determined based on the identified architecture. The running time may be computed or recorded from benchmark tests performed in the multi-processor environment. In process 406, the communication delay between a first and a second computing unit in the multi-processor environment is determined. In process 408, inter-processor communication time and memory communication time are determined.

In process 410, each functional block is assigned to the first or the second computing unit. The assignment is based at least in part on the running times and the communication time. In process 412, the instruction sets to be executed in the multi-processor environment to perform the functions represented by the sequential program are generated. Typically, the sequential code is also used as an input for generating the parallel code. In process 414, activities of the first and second computing units are monitored to detect load imbalance. If load imbalance is detected in process 416, the assignment of the functional blocks to processing units is dynamically adjusted, in process 418.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. sec. 112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

What is claimed is:

1. A method of generating a plurality of instruction sets from a sequential program for parallel execution in a multi-processor environment, comprising:
identifying architecture of the multi-processor environment in which the plurality of instruction sets is to be executed;
determining running time of each of a set of functional blocks of the sequential program based on the identified architecture;
determining communication delay between a first computing unit and a second computing unit in the multi-processor environment; and
assigning each of the set of functional blocks to the first computing unit or the second computing unit based on the running times and the communication time.

2. The method of claim 1, wherein, the architecture the multi-processor environment is user-specified or automatically detected.

3. The method of claim 1, wherein, the architecture of the multi-processor environment is a multi-core processor and the first computing unit is a first core and the second computing unit is a second core.

4. The method of claim 1, wherein, the architecture of the multi-processor environment is a networked cluster and the first computing unit is a first computer and the second computing unit is a second computer.

5. The method of claim 1, wherein, the architecture of the multi-processor environment is, one or more of, a cell, an FPGA, and a GPU.

6. The method of claim 1, wherein, the communication delay comprises inter-processor communication time and memory communication time;
wherein the inter-processor communication time comprises time for data transmission between processors and the memory communication time comprises time for data transmission between a processor and a memory unit in the multi-processor environment.

7. The method of claim 6, wherein, the communication delay, further comprises, arbitration delay for acquiring access to an interconnection network connecting the first and second computing units in the multi-processor environment.

8. The method of claim 1, further comprising, determining communication delay for transmitting between the first computing unit and a third computing unit.

9. The method of claim 1, further comprising, generating the plurality of instruction sets to be executed in the multi-processor environment to perform a set of functions represented by the sequential program.

10. The method of claim 9, wherein the plurality of instruction sets comprise instructions dictating communication and synchronization among the first and second computing units in the multi-processor environment to perform the set of functions represented by the sequential program.

11. The method of claim 1, further comprising, monitoring activities of the first and second computing units in the multi-processor environment when executing the plurality of instruction sets to detect load imbalance among the first and second computing units.

12. The method of claim 10, further comprising, in response to detecting load imbalance among the first and second computing units, dynamically adjusting the assignment of the set of functional blocks to the first and second computing units.

13. The method of claim 1, further comprising, identifying data dependent blocks from the set of functional blocks.

14. The method of claim 1, further comprising, determining the running time of a functional block of the set of functional blocks by performing benchmarking tests using a plurality of varying size inputs to the functional block.

15. The method of claim 1, further comprising, determining the communication delay by performing a benchmarking test to determine network latency and bandwidth.

16. A system of a synthesizer module, comprising:
a resource computing module to determine resource intensity of each of a set of functional blocks of a sequential program based on a particular architecture of the multi-processor environment;
a resource database to store data comprising the resource intensity of each of the set of functional blocks and communication times among computing units in the multi-processor environment;
a scheduling module to assign the set of functional blocks to the computing units for execution; when, in operation, establishes a communication with the resource database to retrieve one or more of the resource intensity and the communication times; and
a parallel code generator module to generate parallel code for execution by the computing units to perform a set of functions represented by the sequential program.

17. The system of claim 16, further comprising, a hardware architecture specifier module coupled to the resource computing module.

18. The system of claim 16, further comprising, a parser data retriever module, coupled to the scheduling module to provide parser data of each of the set of functional blocks to the scheduling module.

19. The system of claim 16, further comprising, a sequential code processing unit coupled to the parallel code generator module.

20. An optimization system, comprising:
a converter module for determining parser data of a set of functional blocks of a sequential program;
a synthesis module for generating a plurality of instruction sets from the sequential program for parallel execution in a multi-processor environment;
a dynamic monitor module to monitor activities of the computing units in the multi-processor environment to detect load imbalance; and
a load adjustment module communicatively coupled to the dynamic monitor module, when, in operation, dynamically adjusts the assignment of the set of functional blocks to the computing units in response to the dynamic monitor module detecting load imbalance among the computing units.

21. The system of claim 20, wherein, architecture of the multi-processor environment comprises, one or more of, a multi-core processor, a cluster, a cell, an FPGA, and a GPU.
